(19) United States
(12) Patent Application Publication
(10) Pub. No.: US 2016/0017915 A1
(43) Pub. Date: Jan. 21, 2016

(54) ROLLING BEARING AND METHOD FOR MANUFACTURING SUCH A ROLLING BEARING

(71) Applicants: Sylvain BUSSIT, Monnaie (FR); Amandine HOUART, SAINT AIGNAN DU CHER (FR); Daniel JANSEN, Schwebheim (DE); Tommy JULLIEN, Tours (FR); Thomas LEPINE, Villandry (FR); Bruno MONTBOEUF, CERELLES (FR)

(72) Inventors: Sylvain BUSSIT, Monnaie (FR); Amandine HOUART, SAINT AIGNAN DU CHER (FR); Daniel JANSEN, Schwebheim (DE); Tommy JULLIEN, Tours (FR); Thomas LEPINE, Villandry (FR); Bruno MONTBOEUF, CERELLES (FR)

(73) Assignee: Aktiebolaget SKF, Goteborg (SE)

(21) Appl. No.: 14/801,042

(22) Filed: Jul. 16, 2015

(30) Foreign Application Priority Data
Jul. 18, 2014 (EP) 14306169.5

(51) Int. Cl. F16C 25/08; F16C 19/06

(52) U.S. Cl. CPC F16C 25/083; F16C 19/06

(57) ABSTRACT

A rolling bearing comprising an outer ring and an inner ring, both rings having a raceway for rolling elements placed therebetween in contact with the raceways. At least one of the rings comprises an envelope having an axial portion and, connected to the edges of the axial portion, two radial portions, and two half-raceways arranged in the envelope to form the raceway of this ring. The rolling bearing further comprises at least one annular preloading element made of an elastic material and arranged inside the envelope to be preloaded axially between a first radial portion of the envelope and a lateral face of a first half-raceway. The rolling bearing comprises at least one damping element radially arranged between the axial portion of the envelope and each of the half-raceways.

### CROSS REFERENCE TO RELATED APPLICATIONS

This is a Non-Provisional Patent Application, filed under the Paris Convention, claiming the benefit of Europe Patent (EP) Application Number 14306169.5, filed on 18 Jul. 2014 (18.07.2014), which is incorporated herein by reference in its entirety.

### TECHNICAL FIELD OF THE INVENTION

The invention relates to a rolling bearing and to a method for manufacturing such a rolling bearing.

### BACKGROUND OF THE INVENTION

Rolling bearings comprising at least one ring provided with two raceways, for example formed by toric wires, mounted in an envelope and preloaded by an elastic element are known from EP-B-1 956 254. Such rolling bearings are often used in steering columns to mitigate the effects of column misalignment.

The wires used in such rolling bearings are manufactured from linear metallic wires which are deformed to obtain a circular shape. The ends of the wires are joined each other, and the junction produces a noise and vibrations when the rolling elements roll onto it. It is also known to use raceways with spherical surfaces formed from a stamped metal sheet. Other causes, such as rugosity of metallic contact surfaces, cause noise and vibrations. Thus, the noise emission of such types of rolling bearings should be reduced.

### SUMMARY OF THE INVENTION

The aim of the invention is to provide a new rolling bearing which has a structure which reduces noise emission and vibrations in operation.

To this end, the invention concerns a rolling bearing comprising an outer ring and an inner ring, both having a raceway for rolling elements placed between the inner and outer rings in contact with the raceways, at least one of the rings comprising an envelope having an axial portion and, connected to the edges of the axial portion, two radial portions, and two half-raceways arranged in the envelope to form the raceway of this ring, the rolling bearing further comprising at least one annular preloading element made of an elastic material and arranged inside the envelope to be preloaded axially between a first radial portion of the envelope and a lateral face of a first half-raceway. This rolling bearing is characterized in that it comprises at least one damping element radially arranged between the axial portion of the envelope and each of the half-raceways.

Thanks to the invention, vibrations and noise are reduced by the damping elements disposed between the half-raceways and the axial portion of the envelope. Another advantage of the present invention is that an axial preload can be exerted on the rolling elements by the damping elements.

According to further aspects of the invention which are advantageous but not compulsory, such a rolling bearing may incorporate one or several of the following features:
The damping element is made of an elastomeric material.
The damping element is made of at least two different materials, one being adapted to exert an axial preload and another being adapted to damp vibrations.
The damping element is formed by a single layer which is in contact with both half-raceways.
The damping element forms a single part with the preloading element.
The damping element is formed by two linings, each lining being in contact with one of the half-raceways.
At least one of the linings forms a single part with the preloading element.
The rolling elements are balls.
At least one of the half-raceways is formed by a wire.
At least one of the half-raceways is an annular ring provided with a contact surface having a spherical shape for contacting the rolling elements.
An edge of the annular ring is in contact with the damping element.
The envelope comprises, on at least one side, an axial portion connected to the radial portion to form an annular chamber shaped like a U in cross section and wherein the annular preloading element is housed in this chamber.
The rolling bearing includes a second preloading element extending axially between the second radial portion and a lateral face of the second half-raceway.

The invention also concerns a method for manufacturing a rolling bearing as mentioned here-above. This method is characterized in that it comprises steps consisting in:
a) manufacturing a preformed envelope having one of its radial portions extending axially from the axial portion of the envelope, in a pre-deformation state,
b) providing the preformed envelope with a layer of damping material on the axial portion and the radial portion in a pre-deformation state,
c) mounting the half-raceways and the rolling elements in the envelope,
d) shaping the envelope by deforming the radial portion towards one of the half-raceways so the radial portion preloads the half-raceways and the rolling elements.

### BRIEF DESCRIPTION OF THE DRAWINGS

The invention will now be explained in reference to the annexed figures, as an illustrative example. In the annexed figures:

FIG. 1 is a partial sectional view of a rolling bearing according to a first embodiment of the invention;

FIG. 2 is a partial sectional view of a rolling bearing according to a second embodiment of the invention;

FIG. 3 is a partial sectional view of a rolling bearing according to a third embodiment of the invention;

FIG. 4 is a partial sectional view of a rolling bearing according to a fourth embodiment of the invention; and

FIG. 5 is a partial sectional view of an envelope, a preloading element and a damping element belonging to a rolling bearing according to a fifth embodiment of the invention, in a pre-deformation state.

### DETAILED DESCRIPTION OF SOME THE PRESENT INVENTION

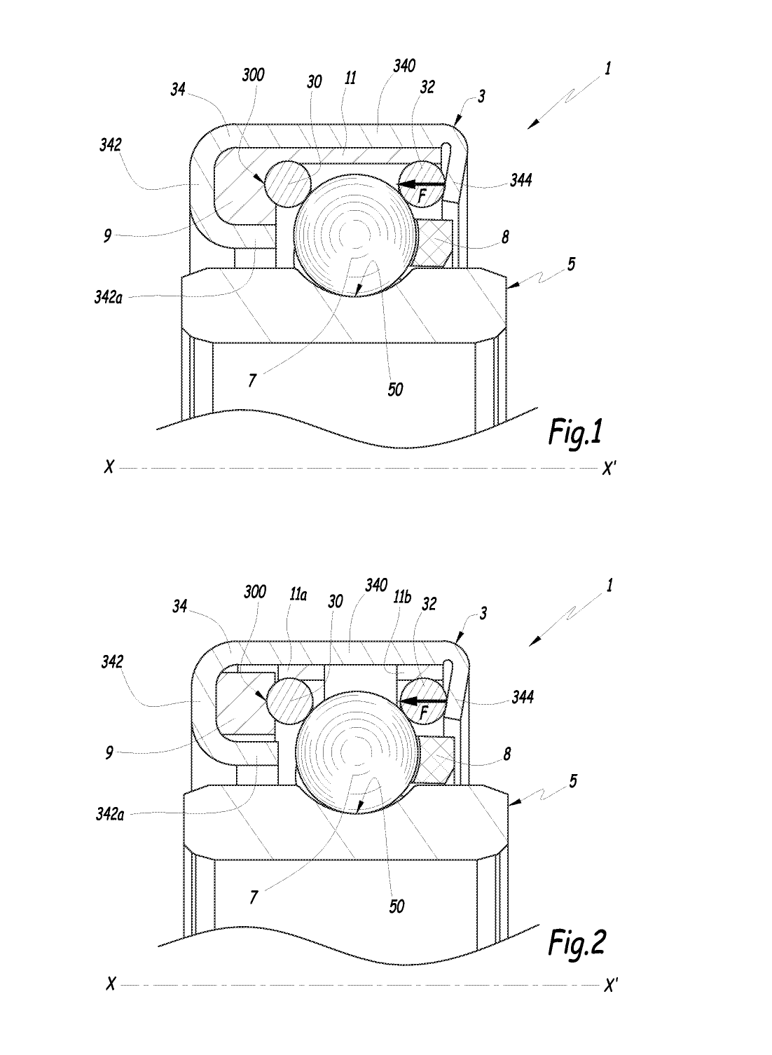

A rolling bearing 1 according to the invention is represented on FIG. 1. This rolling bearing 1 comprises an outer ring 3, an inner ring 5 and rolling elements, which are balls 7 in this example. Each of outer ring 3 and inner ring 5 has raceways for balls 7, which are arranged in a cage 8 which maintains the balls 7 equally spaced, and placed between outer ring 3 and inner ring 5. The inner ring 5 is massive and comprises a concave recess on an outer surface forming a raceway 50 for the balls 7. The raceway of outer ring 3 is formed by two half-raceways. In the example of FIG. 1, the half-raceways of outer ring 3 are wires 30 and 32. Outer ring 3 comprises an envelope 34 in which wires 30 and 32 are arranged. Envelope 34 comprises an axial portion 340, which extends along a rotation axis X-X′ of rolling bearing 1. Envelope 34 also comprises two radial portions 342 and 344 connected to the edges of axial portion 340.

In this description the adjectives “axial” and “radial” are used in reference to rotation axis X-X′.

Radial portion 342 comprises an axial portion 342a which forms an annular chamber shaped like a U in cross-section.

Rolling bearing 1 further comprises an annular preloading element 9 which is made of an elastic material and arranged inside envelope 34 to be preloaded axially between radial portion 342 and a lateral face of one of the half-raceways. In the example shown, preloading element 9 is preloaded against a lateral face 300 of wire 30. Radial portion 344, which is opposed to preloading element 9 along axis X-X′, exerts a preloading force F against wire 32 along axis X-X′. This preloading force F permits to keep contact between rolling elements 7 and wires 30 and 32.

In order to reduce vibrations and noise emission inside rolling bearing 1, rolling bearing 1 comprises at least one damping element 11 radially arranged between axial portion 340 and each of wires 30 and 32. Damping element 11 may be made of an elastomeric material such as rubber. Thanks to damping element 11, wires 30 and 32 are not in direct contact with axial portion 340. This prevents vibrations and noise emission which can occur when two metallic surfaces are in contact. This reduces also the noise and vibrations produced by the rolling of the non-shown junction of the circumferential ends of wires 30 and 32 against balls 7.

Damping element 11 may be overmolded onto envelope 34. Alternatively, damping element 11 may be glued to envelope 34 or attached to envelope 34 by any appropriate means.

As represented on FIG. 1, damping element 11 is formed by a single layer which is in contact with both wires 30 and 32. Damping element 11 forms a single part with preloading element 9. The part formed by preloading element 9 and damping element 11 may be overmolded on envelope 34 or be mounted as a separately manufactured part.

A second, a third, a fourth and a fifth embodiment of the invention are respectively represented on FIGS. 2 to 5. In these embodiments, elements similar to those of the first embodiment have the same references and work in the same way. Only the differences from the first embodiment are detailed here-after.

In the embodiment of FIG. 2, damping element 11 does not form a single part with preloading element 9. Damping element 11 is formed by two linings 11a and 11b which are each in contact with one of wires 30 and 32. Damping linings 11a and 11b are radially aligned with wires 30 and 32, and linings 11a and 11b are axially separated by an empty space.

According to a non-shown embodiment of the invention, damping lining 11a may form a single part with preloading element 9.

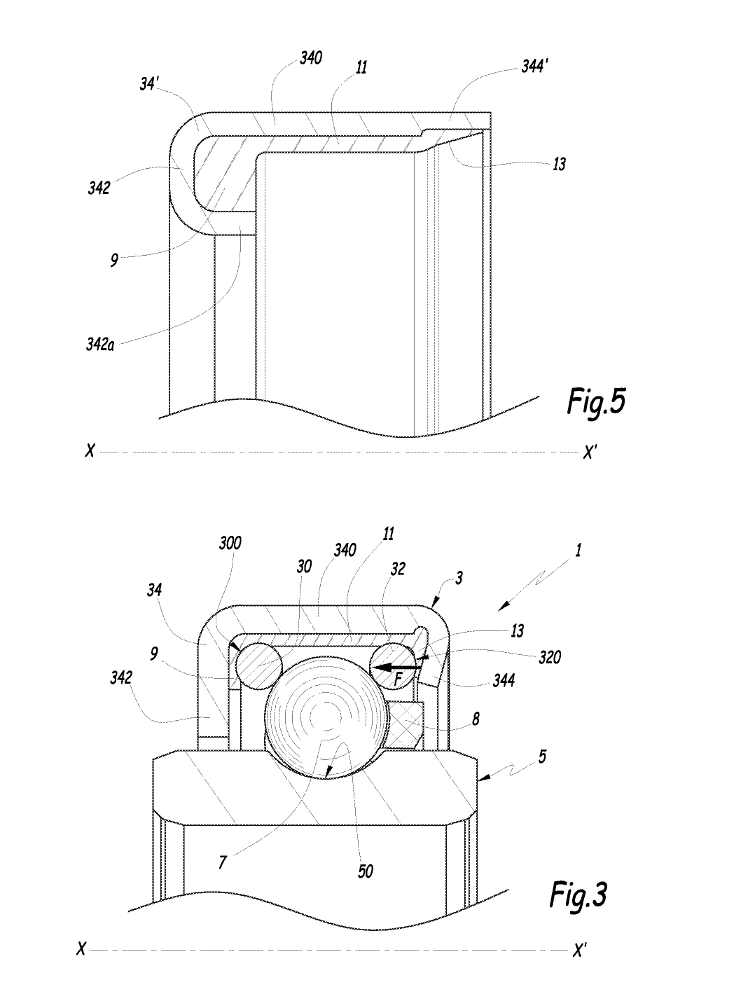

In the embodiment of FIG. 3, preloading element 9 is not arranged inside a U-shaped annular chamber formed by envelope 34. In this embodiment, radial portion 342 is straight and perpendicular to X-X′. Preloading element 9 is formed by a layer of elastic material extending axially between radial portion 342 and wire 30.

In this embodiment, rolling bearing 1 comprises a second preloading element 13 formed by a layer of elastic material extending axially between a lateral face 320 of wire 32 and radial portion 344.

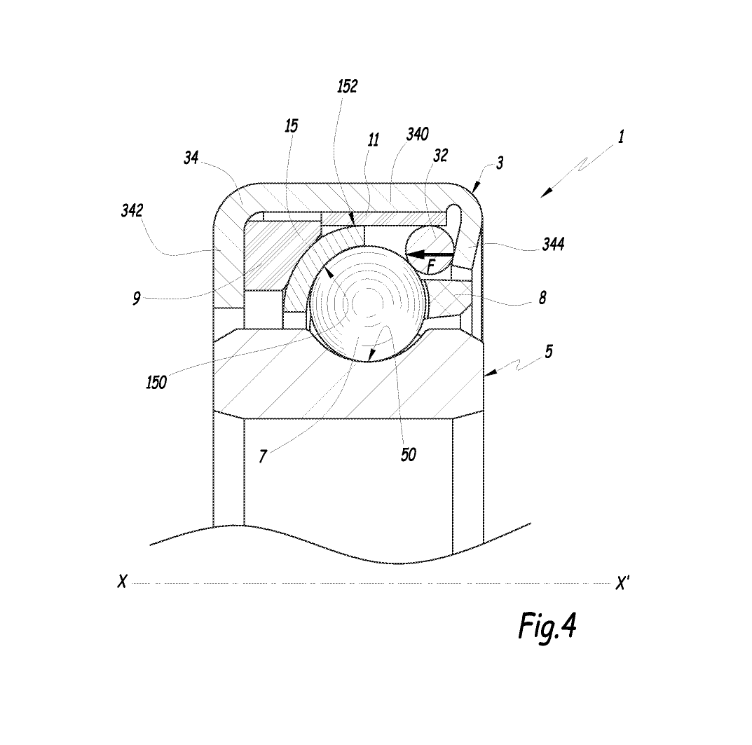

On the embodiment of FIG. 4, the half-raceways of rolling bearing 1 comprise a ring 15 with a spherical annular inner surface 150, which contacts balls 7, and a wire 32 instead of two wires 30 and 32. An outer edge 152 of ring 15 is in contact with damping element 11. Such a ring 15 may be formed from a stamped metal sheet.

According to a non-shown embodiment of the invention, each of the half-raceways may be formed by a ring with a spherical surface.

According to another non-shown embodiment, spherical inner surface 150 may have a large radius of curvature, so that surface 150 is almost flat and defines a contact point with each rolling element if the rolling elements are balls.

On the embodiment of FIG. 5, rolling bearing 1 combines the U-shaped annular chamber of the embodiment of FIG. 1 and the second preloading element 13 of FIG. 3. In such as case, rolling bearing 1 is manufactured thanks to the following method: in a first step represented on FIG. 5, a preformed envelope 34′ is manufactured, in which radial portion 344 is in a pre-deformation state 344′ and extends axially from axial portion 340. The preformed envelope 34′ may be manufactured by forging or stamping.

In a second step, preformed envelope 34′ is provided with a layer of damping material on axial portion 340 and on radial portion 344′.

In a third step, the half-raceways and the rolling elements of rolling bearing 1 are mounted in envelope 34′.

In a final step, envelope 34′ is shaped in its final state 34 by deforming radial portion 344′ towards one of the half-raceways so that, as shown on FIG. 3, radial portion 344 preloads wire 32 and rolling elements 7.

According to a non-shown embodiment of the invention, inner ring 5 may comprise an envelope, half-raceways, a preloading element and a damping element similar to the one described for outer ring 3, while outer ring 3 may comprise a raceway similar to raceway 50.

According to another non-shown embodiment of the invention, damping element 11 may be made of at least two different materials. For example, damping element 11 may include a first material forming a first layer, and a second material radially superimposed to the first material to form a second layer. One of the materials may be adapted to damp vibrations, while the second material may be adapted to exert an axial preload on the rolling elements via the contact between the half-raceways and the rolling elements.

The features of the above described embodiments may be combined to form new embodiments of the invention.

1. A rolling bearing comprising:
an outer ring;
an inner ring; and
each of the outer ring and the inner ring having a raceway for rolling elements placed between the inner ring and the outer ring in contact with the raceways, at least one of the rings comprising:
an envelope having an axial portion and, connected to the edges of the axial portion, two radial portions; and
two half-raceways arranged in the envelope to form the raceway of this ring; and
at least one annular preloading element made of an elastic material and arranged inside the envelope to be preloaded axially between a first radial portion of the envelope and a lateral face of a first half-raceway,
wherein the rolling bearing comprises at least one damping element radially arranged between the axial portion of the envelope and each of the half-raceways.

2. The rolling bearing according to claim 1, wherein the damping element is made of an elastomeric material.

3. The rolling bearing according to claim 1, wherein the damping element is made of at least two different materials, one being adapted to exert an axial preload and another being adapted to damp vibrations.

4. The rolling bearing according to any preceding claim, wherein the damping element is formed by a single layer which is in contact with both half-raceways.

5. The rolling bearing according to claim 4, wherein the damping element forms a single part with the preloading element.

6. The rolling bearing according to claim 1, wherein the damping element is formed by two linings, each lining being in contact with one of the half-raceways.

7. The rolling bearing according to claim 6, wherein at least one of the linings forms a single part with the preloading element.

8. The rolling bearing according to claim 1, wherein the rolling elements are balls.

9. The rolling bearing according to claim 1, wherein at least one of the half-raceways is formed by a wire.

10. The rolling bearing according to claim 1, wherein at least one of the half-raceways is an annular ring provided with a contact surface having a spherical shape for contacting the rolling elements.

11. The rolling bearing according to claim 10, wherein an edge of the annular ring is in contact with the damping element.

12. The rolling bearing according to claim 1, wherein the envelope comprises, on at least one side, an axial portion connected to the radial portion to form an annular chamber shaped having a U in cross section and wherein the annular preloading element is housed in this chamber.

13. The rolling bearing according to claim 1, further comprising a second preloading element extending axially between the second radial portion and a lateral face of the second half-raceway.

14. A method for manufacturing a rolling bearing, wherein the rolling bearing includes:
an outer ring; and
an inner ring,
each of the outer ring and the inner ring having a raceway for rolling elements placed between the inner ring and the outer ring in contact with the raceways, at least one of the rings comprising:
an envelope having an axial portion and, connected to the edges of the axial portion, two radial portions; and
two half-raceways arranged in the envelope to form the raceway of this ring; and
at least one annular preloading element made of an elastic material and arranged inside the envelope to be preloaded axially between a first radial portion of the envelope and a lateral face of a first half-raceway,
wherein the rolling bearing comprises at least one damping element radially arranged between the axial portion of the envelope and each of the half-raceways,
the method comprising steps of:
a) manufacturing the preformed envelope having one of its radial portions extending axially from the axial portion of the envelope, in a pre-deformation state;
b) providing the preformed envelope with a layer of damping material on the axial portion and the radial portion in a pre-deformation state;
c) mounting the half-raceways and the rolling elements in the envelope; and
d) shaping the envelope by deforming the radial portion towards one of the half-raceways so the radial portion preloads the half-raceways and the rolling elements.
